(19) United States
(12) Patent Application Publication
(10) Pub. No.: US 2012/0301704 A1
(43) Pub. Date: Nov. 29, 2012

(54) TITANIUM/TITANIUM ALLOY-AND-RESIN COMPOSITE AND METHOD FOR MAKING THE SAME

(75) Inventors: CHENG-SHI CHEN, Tu-Cheng (TW); DAI-YU SUN, Shenzhen City (CN); YUAN-YUAN FENG, Shenzhen City (CN); YU-QIANG WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/293,509

(22) Filed: Nov. 10, 2011

(30) Foreign Application Priority Data
May 24, 2011 (CN) 201110135326.1

(51) Int. Cl. B32B 3/26; C23C 28/00; B82Y 30/00; B82Y 40/00

(52) U.S. Cl. 428/315.9; 205/200; 977/781; 977/890

(57) ABSTRACT

A titanium/titanium alloy-and-resin composite includes a titanium/titanium alloy substrate, a nano-porous oxide film formed on the substrate, and resin compositions coupled to the surface of the nano-porous oxide film. The nano-porous oxide film has nano pores. The resin compositions contain crystalline thermoplastic synthetic resins. A method for making the titanium/titanium alloy-and-resin composite is also described.

### CROSS-REFERENCE TO RELATED APPLICATIONS

This application is one of the two related co-pending U.S. patent applications listed below. All listed applications have the same assignee. The disclosure of each of the listed applications is incorporated by reference into another listed application.

| Attorney | | |
|---|---|---|
| Docket No. | Title | Inventors |
| US 39535 | TITANIUM/TITANIUM | HUANN-WU |
| | ALLOY-AND-RESIN COMPOSITE | CHIANG et al. |
| | AND METHOD FOR MAKING THE | |
| | SAME | |
| US 39536 | TITANIUM/TITANIUM | CHENG-SHI |
| | ALLOY-AND-RESIN COMPOSITE | CHENN et al. |
| | AND METHOD FOR MAKING | |
| | THE SAME | |

### BACKGROUND

1. Technical Field

The present disclosure relates to titanium/titanium alloy-and-resin composites, particularly to a titanium/titanium alloy-and-resin composite having high bonding strength between titanium/titanium alloy and resin and a method for making the composite.

2. Description of Related Art

Adhesives, for combining heterogeneous materials in the form of a metal and a synthetic resin are in demand in a wide variety of technical fields and industries, such as the automotives and household appliances fields. However, the bonding strength of the metal and resin is weak. Furthermore, adhesives are generally only effective in a narrow temperature range of about −50° C. to about 100° C., which means they are not suitable in applications where operating or environmental temperatures may fall outside the range. Due to the above reason, other bonding methods have been applied that do not involve the use of an adhesive. One example of such methods is by forming bonds through injection molding or other similar process. However, the bonding strength of the metal and resin can be further improved.

Therefore, there is room for improvement within the art.

### BRIEF DESCRIPTION OF THE FIGURES

Many aspects of the disclosure can be better understood with reference to the following figures. The components in the figures are not necessarily drawn to scale, the emphasis instead being placed upon clearly illustrating the principles of the disclosure. Moreover, in the drawings like reference numerals designate corresponding parts throughout the several views.

FIG. 1 is a cross-sectional view of an exemplary embodiment of a titanium/titanium alloy-and-resin composite.

FIG. 2 is a scanning electron microscopy view of an exemplary embodiment of a titanium/titanium alloy substrate being anodized.

FIG. 3 is a cross-sectional view of an exemplary embodiment of a titanium/titanium alloy substrate being anodized.

FIG. 4 is a cross-sectional view of a mold of the composite shown in FIG. 1.

### DETAILED DESCRIPTION

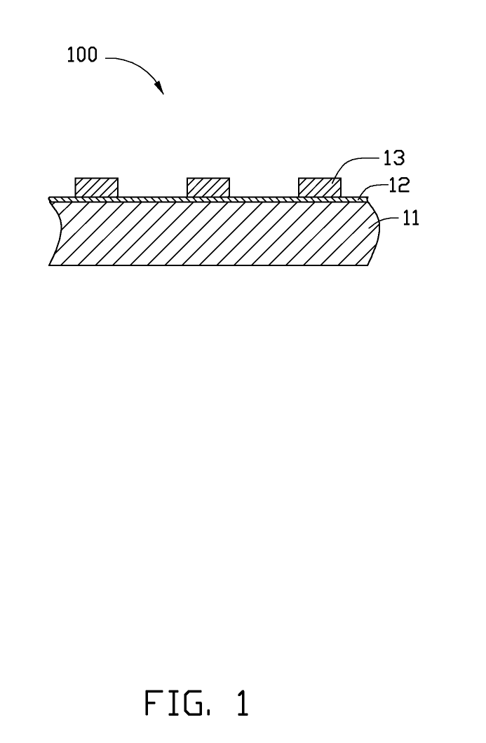

FIG. 1 shows a titanium/titanium alloy-and-resin composite 100 according to an exemplary embodiment. The titanium/titanium alloy-and-resin composite 100 includes a titanium/titanium alloy substrate 11, a nano-porous oxide film 12 formed on the substrate 11, and resin compositions 13 formed on the nano-porous oxide film 12.

The nano-porous oxide film 12 is titanium dioxide film. In this embodiment, the nano-porous oxide film 12 is formed by anodizing the substrate 11.

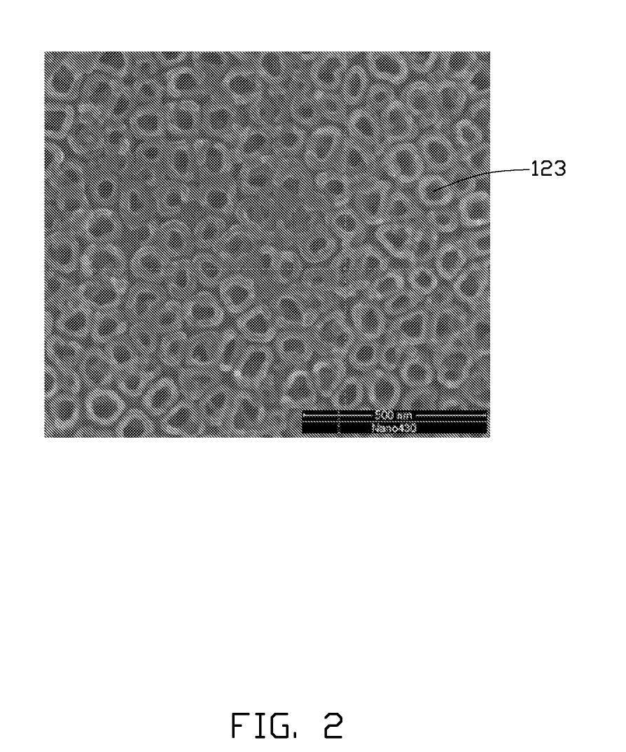

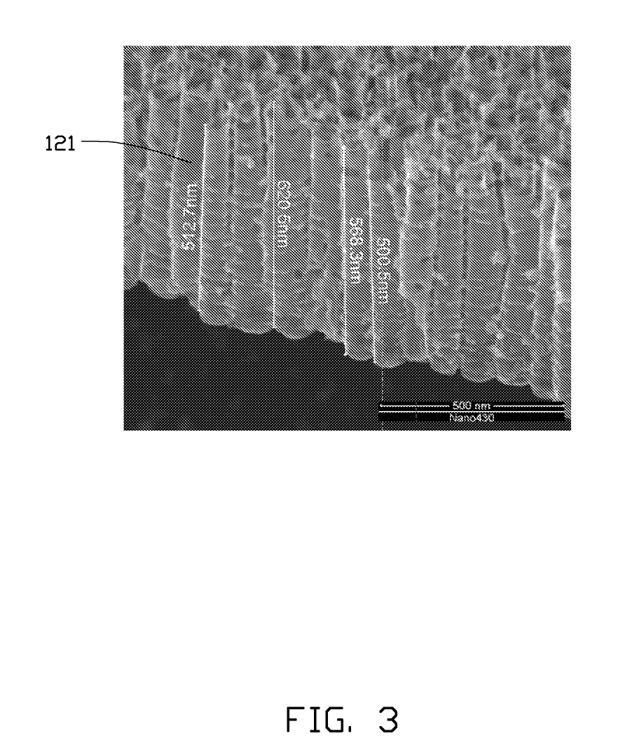

Referring to FIG. 2 and FIG. 3, the nano-porous oxide film 12 formes with a plurality of nano-tubes 121 which has a regular, even distribution in the nano-porous oxide film 12. The nano-tubes 121 define a plurality of nano-pores 123. The pore diameter of the nano-pores 123 may be in a range of about 30 nm-100 nm. The nano-tubes 121 have a length of about 300 nm-700 nm, that is, the nano-porous oxide film 12 has a thickness of about 300 nm-700 nm. The nano-tubes 121 and the nano-pores 123 give the nano-porous oxide film 12 a greater specific surface area and a strong absorbency.

The resin compositions 13 may be coupled to the surface of the nano-porous oxide film 12 by molding. During the molding process, molten resin coats the surface of the nano-porous oxide film 12 first, and under the action of the greater specific surface area and the strong absorbent property of the nano-porous oxide film 12 fills the nano-pores 123 completely, thus strongly bonding the resin compositions 13 to the nano-porous oxide film 12 and the substrate 11. Compared to the conventional injection molding process in which the titanium/titanium alloy substrate is not anodized, the composite 100 in this exemplary embodiment has a much stronger bond between the resin compositions 13 and the substrate 11 (about quintuple the bonding force). The resin compositions 13 may be made up of crystalline thermoplastic synthetic resins having high fluidity. In this exemplary embodiment, polyphenylene sulfide (PPS) and polyamide (PA) can be selected as the molding materials for the resin compositions 13. These resin compositions 13 can bond firmly with the nano-porous oxide film 12 and the substrate 11.

It is to be understood that auxiliary components may be added to the resins to modify properties of the resin compositions 13, for example, fiberglass may be added to PPS. The fiberglass may have a mass percentage of about 30% with regard to the PPS and the fiberglass.

A method for making the composite 100 may include the following steps:

The titanium/titanium alloy substrate 11 is provided.

The substrate 11 is ultrasonically cleaned using anhydrous ethanol and acetone respectively, and then rinsed.

The substrate 11 is chemically polished. The chemical polishing process may be carried out in a water solution containing hydrofluoric acid (HF) and nitric acid (HNO₃), or a water solution of HF and HNO₃. The water solution may be obtained by mixing a HF (having a mass percentage of about 40%), a HNO₃ (having a mass percentage of about 68%), and deionized water at a volume ratio of about 1:1:8. During the polishing process, the water solution may be agitated to improve the polishing effect. Next, the substrate 11 is rinsed in water and then dried.

The substrate 11 is anodized to form the nano-porous oxide film 12. The anodizing process may be carried out in a water solution containing HF and sodium sulfate (Na₂SO₄), or a water solution of HF and Na₂SO₄, with the substrate 11 being an anode, and a stainless steel board being a cathode. The voltage between the anode and the cathode is adjusted to about 15 V-25 V and then directly put into the water solution to start the process. During the anodizing process, the water solution is agitated to control the temperature of the substrate 11 to be not too high and simultaneously even the concentration distribution in the water solution. The Na₂SO₄ may have a molar concentration of about 0.5 mol/L-2 mol/L in the water solution. The HF may have a mass concentration of about 0.5%-1.0% in the water solution. Anodizing the substrate 11 may last for about 15 minutes-20 minutes. Once anodized, the nano-porous oxide film 12 is formed on the substrate 11. Next, the substrate 11 having the nano-porous oxide film 12 is rinsed in water and then dried.

The thickness of the nano-porous oxide film 12, and the pore diameter of the nano-pores 123 in this embodiment are only an example. The thickness of the nano-porous oxide film 12 and the pore diameter of the nano-pores 123 can be changed by adjusting the voltage, the concentration of the water solution, and the lasting time of the anodizing process.

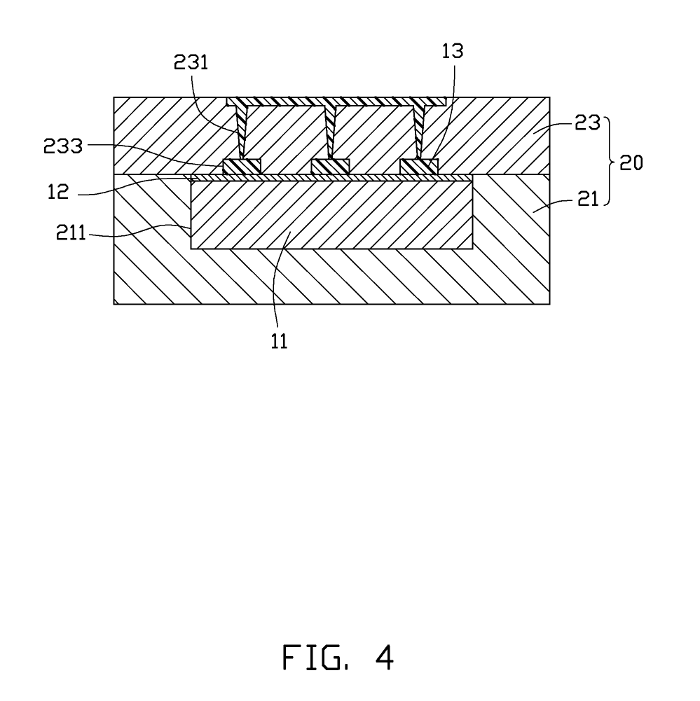

Referring to FIG. 4, an injection mold 20 is provided. The injection mold 20 includes a core insert 23 and a cavity insert 21. The core insert 23 defines several gates 231, and several first cavities 233. The cavity insert 21 defines a second cavity 211 for receiving the substrate 11. The substrate 11 having the nano-porous oxide film 12 is located in the second cavity 211, and molten resin is injected through the gates 231 to coat the surface of the nano-porous oxide film 12 and fill the nano-pores 123, and finally fill the first cavities 233 to form the resin compositions 13, as such, the composite 100 is formed. The molten resin may be crystalline thermoplastic synthetic resins having high fluidity, such as PPS, or PA.

The shear strength of the composite 100 has been tested. The tests indicated that the shear strength of the composite 100 was 20 MPa-30 MPa. Furthermore, the composite 100 has been subjected to a temperature humidity bias test (72 hours, 85° C., relative humidity: 85%) and a thermal shock test (48 hours, −40° C.-85° C., 4 hours/cycle, 12 cycles total), such testing did not result in decreased shear strength of the composite 100.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A titanium/titanium alloy-and-resin composite, comprising:
a titanium/titanium alloy substrate;
a nano-porous oxide film formed on the substrate, the nano-porous oxide film defining nano pores; and
at least a resin composition coupled to the surface of the nano-porous oxide film, the resin composition containing crystalline thermoplastic synthetic resins.

2. The composite as claimed in claim 1, wherein the nano-porous oxide film is titanium dioxide film.

3. The composite as claimed in claim 1, wherein the nano-pores has a pore diameter at a range of about 30 nm-100 nm.

4. The composite as claimed in claim 2, wherein the nano-porous oxide film forms with nano-tubes, the nano-tubes have a length of about 300 nm-700 nm.

5. The composite as claimed in claim 4, wherein the nano-porous oxide film has a thickness of about 300 nm-700 nm.

6. The composite as claimed in claim 4, wherein the resin composition fills the nano-pores of the nano-porous oxide film.

7. The composite as claimed in claim 1, wherein the resin composition is molded crystalline thermoplastic synthetic resin composition.

8. The composite as claimed in claim 1, wherein the crystalline thermoplastic synthetic resin is polyphenylene sulfide or polyamide.

9. The composite as claimed in claim 1, wherein the crystalline thermoplastic synthetic resin is polyphenylene sulfide added with fiberglass, the fiberglass has a mass percentage of about 30% with regard to the polyphenylene sulfide and the fiberglass.

10. A method for making a titanium/titanium alloy-and-resin composite, comprising:
providing a titanium/titanium alloy substrate;
anodizing the substrate to form a nano-porous oxide film on the surface of the substrate, the nano-porous oxide film defining nano pores; and
inserting the substrate in a mold and molding crystalline thermoplastic synthetic resin on the surface of the nano-porous oxide film to form the composite.

11. The method as claimed in claim 10, wherein anodizing the substrate is carried out in a water solution containing hydrofluoric acid and sodium sulfate for about 15-20 minutes with the substrate being an anode, the sodium sulfate has a mol concentration of about 0.5 mol/L-2 mol/L in the water solution, the hydrofluoric acid has a mass concentration of about 0.5%-1.0% in the water solution, anodizing the substrate is conducted at a voltage of about 15 V-25 V.

12. The method as claimed in claim 11, wherein the water solution is agitated during the anodizing process.

13. The method as claimed in claim 10, wherein the crystalline thermoplastic synthetic resin is polyphenylene sulfide or polyamide.

14. The method as claimed in claim 10, wherein the crystalline thermoplastic synthetic resin is polyphenylene sulfide added with fiberglass, the fiberglass has a mass percentage of about 30% with regard to the polyphenylene sulfide and the fiberglass.

15. The method as claimed in claim 10, wherein the nano-porous oxide film is titanium dioxide film.

16. The method as claimed in claim 10, further comprising a step of chemical polishing the substrate before anodizing the substrate.

17. The method as claimed in claim 10, wherein the nano-porous oxide film has a total thickness of about 300 nm-700 nm.

18. The method as claimed in claim 10, wherein the resin composition fills the nano-pores of the nano-porous oxide film.

19. A titanium/titanium alloy-and-resin composite, comprising:
a titanium/titanium alloy substrate;
a nano-porous oxide film formed on the substrate, the nano-porous oxide film defining nano pores; and
at least a resin composition molded to the surface of the nano-porous oxide film, the resin composition containing crystalline thermoplastic synthetic resins.
